(19) United States
(12) Patent Application Publication
(10) Pub. No.: US 2016/0305356 A1
(43) Pub. Date: Oct. 20, 2016

(54) CONTROL APPARATUS OF INTERNAL COMBUSTION ENGINE

(71) Applicant: TOYOTA JIDOSHA KABUSHIKI KAISHA, Toyota-shi, Aichi (JP)

(72) Inventors: Kazuyasu IWATA, Fuji-shi (JP); Akira YAMASHITA, Mishima-shi (JP); Hiroshi OYAGI, Gotenba-shi (JP)

(73) Assignee: TOYOTA JIDOSHA KABUSHIKI KAISHA, Toyota-shi, Aichi (JP)

(21) Appl. No.: 15/103,475

(22) PCT Filed: Dec. 9, 2014
(86) PCT No.: PCT/JP2014/083064

§ 371 Date: Jun. 10, 2016

(30) Foreign Application Priority Data
Dec. 12, 2013 (JP) 2013-257331

(51) Int. Cl. F02D 41/04; F02D 41/26; F02M 26/13; F02D 41/40; F02D 35/02

(52) U.S. Cl. CPC F02D 41/04; F02D 41/403; F02D 35/025; F02M 26/13; F02D 41/26

(57) ABSTRACT

A control apparatus includes a control member performing a center position control to align a specific crank angle of an engine with EGR system, which angle is called as center position, with a reference position when the engine is driven under a predetermined range. The center position is a geometric center of a figure defined by a transition of heat generation ratio through fuel combustion. The control member runs an ignition acceleration procedure when the engine satisfies at least one of specific conditions during an exhaust gas recirculation under the center position control. The ignition acceleration procedure is to inject more fuel for a pilot injection than a base amount determined in accordance with the center position control. The specific conditions includes: a condition that an engine load is smaller than a threshold value; and a condition that an engine rotational speed is smaller than a threshold value.

### TECHNICAL FIELD

This invention relates to control apparatuses of internal combustion engines having EGR devices.

### BACKGROUND ART

Controlling fuel combustion states, in combustion cycles of internal combustion engines, have conventionally been focused for more enhanced engine characteristics.

A conventional control apparatus (hereinafter referred to as “conventional apparatus”) of an engine with an EGR device, for example, uses a combustion center angle (a crank angle at which 50% of the total amount of heat generation through a power stroke has been generated) as one of target indicators for less emission of nitrogen oxides and particle matters included in exhaust gas. In particular, the conventional apparatus calculates the combustion center angle in a particular manner, and then adjusts several parameters including a fuel injection timing to decrease the difference between the calculated combustion center angle and an actual combustion center angle (see the patent literature, JP 2011-202629, in Citation List).

The “combustion center angle” of the conventional apparatus is hereinafter referred to as “50% heat generation angle”, and internal combustion engines are hereinafter referred to as “engines”, for the sake of convenience.

### CITATION LIST

### Patent Literature

JP 2011-202629 A

### SUMMARY OF INVENTION

The conventional apparatus uses the 50% heat generation angle in view of the exhaust gas purification, as described above. Inventors of this application have discussed further applicability of the 50% heat generation angle to enhancements of other engine characteristics (e.g., the fuel consumption rate). Results of the discussion will be described below.

Engines may employ the multistage fuel injection, which is an injection method to inject fuel multiple times in one combustion cycle. In particular, the multistage fuel injection may include, for example, one or more pilot injections prior to a main injection.

FIGS. 9A and 9B are reference drawings each illustrating an example of the relationship between crank angle and heat generation under the multistage fuel injection including one pilot injection and one main injection. The “heat generation ratio” in FIG. 9A represents an amount of heat generated through fuel combustion during a period of rotation of the crankshaft at a unit crank angle (i.e., a unit amount of change in rotational position of the crankshaft). In other words, the heat generation ratio represents an amount of heat generation per unit crank angle. The “generated heat percentage” in FIG. 9B represents a percentage of an accumulated heat amount generated from the combustion initiation to a certain crank angle with respect to the total amount of heat generation. The “50% heat generation angle” of the conventional apparatus thus corresponds to the crank angle at which the “generated heat percentage” reaches to 50%.

The waveform in FIG. 9A (the curved line C1) has first local maximum value Lp due to the pilot injection started at the crank angle θ1 and second local maximum value Lm due to the main injection started at the crank angle θ2. The crank angle θ3 in FIG. 9B corresponds to the 50% heat generation angle.

FIGS. 10A and 10B are reference drawings each illustrating an example of the relationship between crank angle and heat generation. This example differs from the previous example of FIGS. 9A and 9B in that the “start time of the pilot injection”, the crank angle θ1, is advanced by Δθp to the crank angle θ0.

The waveform in FIG. 10A (the curved line C2) shows an advance of the initial crank angle, at which heat generation due to the pilot injection, by the crank angle Δθp. However, the waveform in FIG. 10B shows no changes in the 50% heat generation angle, the crank angle θ3, even though the advance of the initial crank angle. In other words, the 50% heat generation angle has no one-to-one relationship to fuel combustion states. This is because the amount of heat generation through the pilot injection remains unchanged regardless of change in the accumulation start point of the amount of heat generation, such as the change from θ1 to θ0, thus keeping the crank angle at which 50% of the total amount of heat generation has been generated (the crank angle θ3) unchanged.

FIG. 11 is a reference drawing illustrating an example of the relationship between the 50% heat generation angle and deterioration rate of the fuel consumption rate. The curved lines Hb1 to Hb3 represent the relationships under “low load and low rotational speed”, “medium load and medium rotational speed” and “high load and high rotational speed”, respectively. The curved lines are drawn based on measured results of experiments by the inventors.

The curved lines in FIG. 11 show that the 50% heat generation angles for the minimum deterioration rate of the fuel consumption rate (i.e., the 50% heat generation angle for the best fuel consumption rate) vary depending on the load and/or the rotational speed of an engine. In other words, the deterioration rate varies depending on the load and/or the rotational speed of the engine, even if the engine is controlled to keep the 50% heat generation angle at a certain reference value (fixed value). Hence, the 50% heat generation angle has no one-to-one relationship to the fuel consumption rate.

In view of the facts shown in FIGS. 9 to 11, the 50% heat generation angle of the conventional apparatus fails to represent fuel combustion states sufficiently, thus being unsuitable to measure the fuel consumption rate of engines, even though being suitable for the exhaust gas purification.

The fuel combustion states typically affect not only the fuel consumption rate of engines but also the engines′ sound produced through the fuel combustion (hereinafter referred to as “combustion noise”). In consideration of the irrelevance of the 50% heat generation angle to represent fuel combustion states, the combustion noise has also no one-to-one relationship to the 50% heat generation angle. Hence, the 50% heat generation angle is unsuitable to measure the combustion noise.

Consequently, the 50% heat generation angle of the conventional apparatus is unsuitable to measure the fuel consumption rate and the combustion noise of engines. In other words, controlling engines by using the 50% heat generation angle as a target indicator fails to improve the engines' characteristics, such as the fuel consumption rate and the combustion noise, appropriately.

To solve the above problems, it is an object of the present invention to provide a control apparatus that enables an internal combustion engine having an EGR device to improve its fuel consumption rate and reduce its combustion noise.

To achieve the above object, an aspect of the present invention provides a control apparatus of an internal combustion engine having an EGR device. The control apparatus comprises a control member performing a “center position control” to align “a crank angle defined as a center position” with a reference position when the engine is driven under a predetermined range for driving status, The “center position” is a geometric center of a figure defined by heat generation ratio through a fuel combustion in a cylinder of the engine.

In particular, the control member is configured to run an “ignition acceleration procedure” when at least one of specific conditions is satisfied during an exhaust gas recirculation with the EGR device under the center position control. The ignition acceleration procedure is to inject more fuel for a pilot injection of the engine before a main injection than a base amount for the pilot injection determined in accordance with the center position control. The specific conditions include “first condition that a load of the engine is smaller than a threshold load” and “second condition that a rotational speed of the engine is smaller than a threshold rotational speed”.

Before describing how the above control apparatus achieves the above object, the following items (A) to (C) will be described below.

(A) Definitions of the “center position” in heat generation ratio in the present invention

(B) A relationship between the center position and a degree of fuel consumption

(C) A relationship between fuel combustion states and combustion noises.

### (A) Definitions of the Center Position in Heat Generation Ratio

The center position in heat generation ratio of the present invention is represented in terms of a rotational position of a crankshaft (i.e., a crank angle). In particular, the center position is defined by the following Definition 1 to Definition 5.

### (Definition 1)

As first definition, the center position is defined as follows:

A crank angle corresponding to the geometric center of a figure (area), illustrated on a rectangular coordinate system, between “a curve of the heat generation ratio with the crank angle on the abscissa axis (x-axis) and the heat generation ratio on the ordinate axis (y-axis)” and “the abscissa axis (x-axis)”.

The figure (area) in accordance with this definition (the Definition 1) is illustrated in FIG. 1 with diagonal lines. The figure (the area marked with diagonal lines) will be described in detail below.

In addition, the “heat generation ratio” represents, as described above by referring to FIGS. 9 and 10, an amount of heat generated through fuel combustion during a period of rotation of the crankshaft at a unit crank angle (i.e., an amount of heat generation per unit crank angle). This definition of the heat generation ratio will also be applied to the following Definitions 2 to 5.

### (Definition 2)

As second definition, the center position is defined as follows:

A specific crank angle (Gc) at which a value obtained by integrating each product of value A (θ-Gc) by value B (dQ(θ)) with respect to crank angle (θ) is zero(0), where the value A is obtained by subtracting the specific crank angle (Gc) from each sample crank angle (θ) through a combustion cycle, and the value B is a heat generation ratio (dQ) at the sample crank angle (θ).

In other words, the center position in accordance with this definition (the Definition 2) is a crank angle that satisfies the following formula (1). In the formula (1), CAs represents a crank angle at which a certain fuel combustion starts, CAe represents a crank angle at which the certain fuel combustion ends, θ represents a crank angle, and dQ(θ) represents a heat generation ratio at the crank angle θ.

∫_{CAs}^{CAe}(θ−Gc)dQ(θ)dθ=0 (1)

### (Definition 3)

As third definition, the center position is defined as follows:

A specific crank angle (Gc) at which “the sum of each product of a heat generation ratio (dQ(θ)), at a more advanced crank angle than the specific crank angle (Gc), by a crank angle difference (Gc−θ)” is equal to “the sum of each product of a heat generation ratio (dQ(8)), at a more retarded crank angle than the specific crank angle (Gc), by a crank angle difference (θ−Gc)”.

In addition, the “crank angle difference” used in this definition represents a difference in crank angle between the specific crank angle (Gc) and each crank angle (θ).

In other words, the center position in accordance with this definition (the Definition 3) is a crank angle that satisfies the following formula (2). In the formula (2), CAs, CAe, θ, and dQ(θ) represent the same parameters as in the formula (1).

∫_{CAs}^{Gc}(Gc−θ)dQ(θ)dθ=∫_{Gc}^{CAe}(θ−Gc(dQ(θ)dθ (2)

Furthermore, in other words, the center position (Gc) in accordance with this definition (the Definition 3) is a specific crank angle, which is from the start angle to the end angle of a fuel combustion in a power stroke, at which “a value obtained by integrating each product of value A by value B with respect to crank angle from the start angle to the specific crank angle” is equal to “a value obtained by integrating each product of value C by value D with respect to crank angle from the specific crank angle to the end angle”, where the value A is a difference in crank angle between first angle (any crank angle from the start angle to the specific crank angle) and the specific crank angle, the value B is a heat generation ratio at the first angle, the value C is a difference in crank angle between second angle (any crank angle from the specific crank angle to the end angle) and the specific crank angle, and the value D is a heat generation ratio at the second angle.

### (Definition 4)

As fourth definition, the center position is defined as follows:

A crank angle (Gc) calculated by the following formula (3),

$$Gc = \frac{{\int }_{CAs}^{CAe} ( θ - CAs ) d Q ( θ ) d θ}{{\int }_{CAs}^{CAe} d Q ( θ ) d θ} + CAs \qquad ( 3 )$$

where CAs represents a crank angle at which a certain fuel combustion starts in a certain combustion cycle, CAe represents a crank angle at which the certain fuel combustion ends in the certain combustion cycle, θ represents a crank angle, and dQ(θ) represents a heat generation ratio at the crank angle θ.

In addition, the formula (3) used for this definition (the Definition 4) can be derived from the formula (1) and the formula (2) with respect to the crank angle Gc.

### (Definition 5)

As fifth definition, the center position is defined as follows:

A specific crank angle obtained by (i) dividing “a value of integral of each product of a crank angle difference by a heat generation ratio” by “an area defined by a curve of heat generation ratio with crank angle” and (ii) adding the combustion start angle to the value of (i).

This definition is to explain the formula (3) of the Definition 4 in words,

The center position in heat generation ratio of the present invention can be defined as above.

In addition, the Definitions 1 to 5 define the same subject (the center position in heat generation ratio) from different perspectives. Hence, the same crank angle (center position) is supposed to be obtained from an identical curve (waveform) of a fuel combustion by using any one of the Definitions 1 to 5. In this regard, any one of the Definitions 1 to 5 can be chosen in consideration of statuses of an engine for which the control apparatus is used (for example, types of the engine, structures of the engine, and types of sensors mounted on the engine) to obtain the center position in heat generation ratio.

### (B) A Relationship Between the Center Position and a Degree of Fuel Consumption

Although a typical engine can convert a part of total energy generated through fuel combustion to work to rotate a crankshaft, the rest thereof is lost. This energy loss includes the cooling loss in which the rest is released in the form of heat from the engine, the exhaust loss in which the rest is released to the atmosphere by the exhaust gas, the pumping loss caused through the intake stroke and the exhaust stroke, and the mechanical resistance loss. The cooling loss and the exhaust loss typically account for a large share of the total of the energy loss. Hence, reducing the cooling loss and the exhaust loss can effectively enhance the degree of fuel consumption (for example, fuel consumption rate).

However, the cooling loss and the exhaust loss have a trade-off relationship therebetween. In other words, reducing the cooling loss causes an increase of the exhaust loss, and reducing the exhaust loss causes an increase of the cooling loss. In view of this relationship, controlling fuel combustion to reduce “the sum (total) of the cooling loss and the exhaust loss” can enhance the degree of fuel consumption.

In this regard, fuel combustion states typically vary depending on “various parameters having an effect on the fuel combustion status” such as a fuel injection amount and a fuel injection timing. Those parameters are hereinafter referred to as “combustion parameters”. However, predetermining each appropriate combustion parameter(s) for individual driving status, for example by experiments in advance, is typically difficult. Furthermore, this predetermining processing typically requires enormous time, even if the appropriate parameter(s) can be predetermined. Thus, systematic methods to determine the combustion parameters for controlling fuel combustion states are desired.

In terms of the systematic methods, the above control apparatus employs the “center position in heat generation ratio”, as a target indicator representing the fuel combustion states, in place of the 50% heat generation angle employed in the conventional apparatus.

FIGS. 1A and 1B are drawings to explain the center position more specifically. FIG. 1A illustrates an example in which a pilot injection is started at the crank angle θ1 and the main injection is started at the crank angle θ2. The center position Gc in this example, in accordance with the above definitions, corresponds to the crank angle θ4 in FIG. 1A. In addition, each curve (waveform) in FIGS. 1A and 1B corresponds to that of the conventional apparatus in FIGS. 9A and 9B and FIGS. 10A and 10B .

In FIG. 1B, the start timing of the pilot injection (the crank angle θ1 in FIG. 1A) is advanced by Δθp to the crank angle θ0. As a result, the center position Gc moves by Δθg to more advanced position, the crank angle θ4′, in accordance with any of the above definitions (for example, the center position corresponds to the geometric center G of the figure (area) with diagonal lines in accordance with the Definition 1). Thus, the center position Gc moves depending on the change in fuel combustion states (for example, the start timing of the pilot injection as in this example).

Consequently, “the center position in heat generation ratio” of the present invention is a parameter to represent the fuel combustion states more properly than the 50% heat generation angle of the conventional apparatus.

Next, FIG. 2 is an explanation drawing illustrating an example of the relationship between the center position and deterioration rates of the fuel consumption rate. The curved lines Gc1 to Gc3 represent the relationships under “low load and low rotational speed”, “medium load and medium rotational speed” and “high load and high rotational speed”, respectively. The curved lines are drawn based on measured results of experiments by the inventors. In addition, each curve (waveform) in FIG. 2 corresponds to that of the conventional apparatus in FIG. 11.

The curved lines in FIG. 2 show that the center position for the minimum deterioration rate of the fuel consumption rate (i.e., the center position for the best fuel consumption rate) is a specific crank angle θa, regardless of the load and/or the rotational speed of an engine. In other words, controlling the engine to keep the center position at a reference position (a fixed position) enables the deterioration rate to stay at a certain value, even if the load and/or the rotational speed of the engine vary. Hence, the center position substantially has one-to-one relationship to the fuel consumption rate.

In view of the one-to-one relationship, the center position is a parameter properly representing the fuel combustion states. Thus, controlling the center position close to a predetermined target position (for example, a position around the crank angle θa) regardless of the load and/or the rotational speed of the engine enables the fuel consumption rate to be enhanced. In other words, a center position to enhance the fuel consumption rate can be specified by defining the relationship between the center position and the fuel consumption rate.

As described above, “the center position in heat generation ratio” of the present invention is a parameter that enables the degree of fuel consumption (for example, the fuel consumption rate) to be uniquely specified, unlike the 50% heat generation angle of the conventional apparatus. In other words, “a reference position for the center position to enhance the fuel consumption rate” can be specified based on the relationship between the center position and the degree of fuel consumption. Hence, controlling the fuel combustion states to align the center position with the reference position (i.e., the center position control) enables the fuel consumption rate to be enhanced. This enhancement is unable to be achieved by using the 50% heat generation angle of the conventional apparatus.

In addition, a range for driving statuses in which the center position control should be performed (i.e., the “predetermined range for driving status” used in the control apparatus) can be determined based on the fuel consumption rate and other characteristics of the engine (e.g., a structural strength and a heat tolerance of the engine, a cold start-up performance, and a performance in exhaust gas purification).

### (C) A Relationship Between Fuel Combustion States and Combustion Noises

Under the center position control, an actual combustion noise may become louder than an estimated noise based on the load and the rotational speed, if the engine is driven in the range in which “a load of the engine is smaller than a threshold load” and/or “a rotational speed of the engine is smaller than a threshold rotational speed” during an exhaust gas recirculation with the EGR device. This louder noise was found based on measured results of experiments by the inventors.

The combustion noise typically becomes loud relative to an increase rate of in-cylinder pressure through the fuel combustion (for example, a change rate of in-cylinder pressure per unit time when the in-cylinder pressure increases). Thus, the combustion noise becomes louder with increasing degree of the increase rate of in-cylinder pressure. In other words, the combustion noise becomes loud when the in-cylinder pressure rapidly rises. The “in-cylinder pressure” is hereinafter referred to as “cylinder pressure” for the sake of simplicity.

FIG. 3 and FIG. 4 are drawings to explain transitions of the cylinder pressure through fuel combustion more specifically. FIG. 3 shows that the cylinder pressure varies due to a movement of a piston, a fuel combustion by the pilot injection, and a fuel combustion by the main injection. In FIG. 3, the actual transition of the cylinder pressure (for example, a pressure detected with a cylinder pressure sensor) corresponds to the total of the transitions due to the movement of the piston, the pilot injection, and the main injection.

In particular, the pilot injection and the main injection in this example are started when the piston closes to the top dead center (TDC) of the compression stroke. Ignition of fuel of the pilot injection begins after a lapse of an ignition delay τp1 from the start of the pilot injection. Then, the fuel of the pilot injection burns to change the cylinder pressure. On the other hand, ignition of fuel of the main injection begins after a lapse of an ignition delay τml from the start of the main injection. Then, the fuel of the main injection burns in a burning time mBP1 to change the cylinder pressure. The maximum pressure due to the main injection is mPmax1.

The ignition delay in this example represents “a time length from the start of a fuel injection to the start of heat generation (or the start of change of cylinder pressure) due to burning of the fuel”, as shown in FIG. 3.

In this example, the start timings of the pilot injection and the main injection are determined to arrange first burning due to the pilot injection and second burning due to the main injection continuously (i.e., to allow the first burning and the second burning to connect each other). In other words, these timings are determined to start the second burning (i.e., the ignition of fuel of the main injection) during the first burning (i.e., a period in which the cylinder pressure changes due to the pilot injection) to achieve the continuous burning. Furthermore, an injection length of the main injection is determined to enable the ignition of the main injection to start in the middle of the main injection (in the middle of the injection length) and to enable the main injection to continue after the ignition.

As a result of the turnings, the cylinder pressure of this example transits as shown in FIG. 3. The increase rate of the cylinder pressure (i.e., the gradient of the transition of the cylinder pressure) is θ1, and the maximum cylinder pressure is Pmax1. In this example, the increase rate θ1 of the cylinder pressure is approximately determined, for the sake of simplicity, by comparing the cylinder pressure at a time of the ignition of the pilot injection (the point A in the figure) with that at a time of the maximum cylinder pressure (the point B).

The time lag from the injection to the ignition (the ignition delays τp1 and τm1) relates to the fuel ignition process. in particular, fuel injected into a cylinder (fuel spray) mixes with gas in the cylinder, receives heat of the gas to be evaporated, and disperses into the gas around the fuel spray to form air-fuel mixture. Pre-ignition reactions including low-temperature oxidation proceed in the air mixture, thus further rising the temperature of the air-fuel mixture. On the other hand, the air-fuel ratio of the mixture changes depending on the degree of mixing or dispersing of the evaporated fuel (e., an amount of gas to which fuel mixes or disperses) and an amount of air included in the gas (for example, the EGR rate). Then, when the air-fuel ratio and the temperature of the mixture satisfy required conditions to enable its ignition, the mixture ignites.

Due to the above process, the length of the ignition delay varies depending on various factors such as the temperature of gas in the cylinder, the composition of the gas (e.g., the amount of air in the gas), the flowability of the gas, the composition of fuel, the size of fuel droplets, and the degree of mixing or dispersing.

For example, the proportion of air to the gas in the cylinder decreases (or, the proportion of inactive gas to the gas increases) with increasing amount of the EGR rate, then the injected fuel needs to mix with a larger amount of the gas having a larger EGR rate and to disperse into a larger area to form an air-fuel mixture having an appropriate air-fuel ratio to burn. Furthermore, when the amount of gas to be mixed with or dispersed by the fuel increases, an amount of fuel included in the air-fuel mixture per unit volume (in other words, the volume of the air-fuel mixture to be heated through the pre-ignition reaction increases), and thus the temperature rise of the air-fuel mixture through the pre-ignition reaction is reduced. Due to these reasons, the ignition delay broadens (the time length of the ignition delay gets longer) with increasing amount of the EGR rate.

Furthermore, when the temperature of gas in the cylinder decreases, the injected fuel (the fuel spray) in the cylinder needs longer time to evaporate. Due to this reason, the ignition delay broadens (the time length of the ignition delay gets longer) with decreasing temperature of the gas in the cylinder.

FIG. 4 illustrates a transition of cylinder pressure when the ignition delay broadens. In the example of FIG. 4, the pilot injection and the main injection start and end at the same timings as in the example of FIG. 3. However, ignition of fuel of the pilot injection begins after a lapse of an ignition delay τp2 from the start of the pilot injection, which is longer than the ignition delay τp1 (ie., τp2>τp1). Furthermore, ignition of fuel of the main injection begins after a lapse of an ignition delay τm2 from the start of the main injection, which is longer than the ignition delay τm1 (i.e., τm2>τm1).

As a result of the broadening of the ignition delay in this example, the burning of fuel of the pilot injection and the burning of fuel of the main injection mostly overlap. Furthermore, the amount of fuel in the cylinder at the ignition of the main injection (i.e., the amount of fuel of the main injection injected from the start timing to the ignition timing) is larger than that of the example in FIG. 3 (under normal ignition delay), since the ignition delay of the main injection broadens from τm1 to τm2. Thus, a larger amount of fuel burns in a shorter time through the main injection compared with the example of FIG. 3 (under normal ignition delay). In particular, the fuel of the main injection burns in a burning time mBP2, which is shorter than the burning time mBP1 (i.e., mBP2<mBP1). Furthermore, the maximum pressure due to the main injection becomes mPmax2, which is larger than the maximum pressure mPmax1 (i.e., mPmax2>mPmax1).

Due to the rapid fuel burning of the main injection, the cylinder pressure of this example transits as illustrated in FIG. 4. The increase rate θ2 of the cylinder pressure is larger than θ1 of the example of FIG. 3 (θ2>θ1) Furthermore, the maximum cylinder pressure Pmax2 is larger than Pmax1 (Pmax2>Pmax1). In this example, the increase rate θ2 is approximately determined by the same method as in the example of FIG. 3.

As described by referring to FIG. 3 and FIG. 4, when the ignition delay broadens, the cylinder pressure changes more rapidly, and the increase rate of the cylinder pressure becomes larger. In other words, when the ignition delay broadens, the combustion noise becomes louder.

The engine to which the control apparatus of the present invention is employed has an EGR device. When the engine further has a supercharger, the engine driven in “a range where the engine load is small” and/or “a range where the engine rotational speed is small” typically has a shorter response speed of the supercharging pressure (a time length from an instruction to change the supercharging pressure to a response of the actual supercharging pressure) than the engine driven in other driving range. Hence, the EGR rate in these driving ranges may become larger than that in other driving range, due to a delay in response of the supercharging pressure. Furthermore, even when the engine has no supercharger, the same phenomenon may occur on one degree or another. In addition, reducing the EGR rate in those driving range is undesirable in view of reducing the amount of NOx included in exhaust gas. Furthermore, when the engine is cold-started in those driving range, the temperature of gas in the cylinder may be low enough to heavily affect the ignition delay regardless of whether the supercharger is used.

As a result, when the engine is driven in the driving ranges, the ignition delay of fuel may broaden.

Furthermore, the reference position of the center position under the center position control is often set as a crank angle near the top dead center to enhance the fuel consumption rate. In other words, setting the reference position at “a position where the center position control enables the fuel consumption rate to be enhanced” typically causes an extreme change in cylinder pressure during the fuel combustion. This is because the volume of the combustion chamber for the fuel combustion is almost the minimum size and thus the fuel combustion in such small area causes a larger change in cylinder pressure than that in a larger combustion chamber (for example, the center position is set at a position far away from the top dead center).

As a result, broadening the ignition delay heavily affects the cylinder pressure, thus even small broadening of the ignition delay may highly increase the increase rate of the cylinder pressure.

Due to the reasons described above, driving the engine in the above specific driving ranges during the exhaust gas recirculation under the center position control may increase the combustion noise because of the fuel ignition delay.

In view of the above, the control apparatus of the present invention runs the ignition acceleration procedure when at least one of specific conditions is satisfied during an exhaust gas recirculation under the center position control. The specific conditions includes: first condition that a load of the engine is smaller than a threshold load; and second condition that a rotational speed of the engine is smaller than a threshold rotational speed.

The ignition acceleration procedure is a procedure “to inject more fuel for a pilot injection than a base amount for the pilot injection determined in accordance with the center position control” as described above. In addition, under the ignition acceleration procedure, an amount of fuel for the main injection may be decreased by the increasing amount for the pilot injection.

Under the ignition acceleration procedure, increasing the fuel injection amount by the pilot injection (hereinafter referred to as “pilot injection amount”) increases the fuel amount included in the air-fuel mixture per unit volume around the fuel spray, and then the temperature of the air-fuel mixture rises rapidly. Furthermore, increasing the pilot injection amount also increases the time length for the injection (injection time), and then the air-fuel mixture mixes with and disperse into larger amount of the gas in the cylinder. Hence, this procedure reduces the worsening of the ignition delay even when the engine satisfies one of the specific conditions, compared with a case without the procedure.

In other words, finding a new knowledge that “the combustion noise increases under the center position control when the one of the specific conditions is satisfied” enables “the center position control to enhance the fuel consumption rate” and “the ignition acceleration procedure to reduce the combustion noise” to be performed at an appropriate timing. Hence, the control apparatus of the present invention is able to achieve enhancing the fuel consumption rate as well as reducing the combustion noise.

As described above, the control apparatus of the present invention is able to reduce the worsening of the combustion noise due to the fuel ignition delay even when the reference position is set at a positon where the center position control enables the fuel consumption rate to be enhanced. In other words, the control apparatus is able to achieve the both of enhancing the fuel consumption rate of the engine and reducing the combustion noise. Consequently, the control apparatus of the present invention achieves the object to enable an internal combustion engine having an ECR device to improve its fuel consumption rate and reduce its combustion noise.

The “increasing amount” of the pilot injection for the “ignition acceleration procedure” is determined to an amount to reduce the worsening of the ignition delay. For example, the increasing amount can be determined based on a degree of the worsening of the ignition delay. The degree can be detected by comparing a default ignition delay (normal value) defined by experiments and an actual ignition delay (worsened value).

In addition, increasing the pilot injection amount typically increases the output torque of the engine. When this increase in output torque heavily affect the engine's operation (for example, when this increase become too large to ignore from the view point of the drivability), the ignition acceleration procedure may further include “decreasing the amount of fuel for the main injection by the increasing amount for the pilot injection” in addition to the increase of the pilot injection amount. To the contrary, when this increase in output torque hardly affect the engine's operation (for example, when this increase is small enough to ignore from the view point of the drivability), the amount of fuel for the main injection is not necessarily decreased. Furthermore, the ignition acceleration procedure may further include “decreasing the amount of fuel for the main injection by the increasing amount for the pilot injection” in addition to the increase of the pilot injection amount, regardless of the impact on the drivability.

The control apparatus of the present invention runs the ignition acceleration procedure when the engine satisfies one of the specific conditions under the center position control. However, the control apparatus may run the ignition acceleration procedure when “the engine satisfies one of the specific conditions” and “the degree of the fuel ignition delay is larger than a predetermined threshold delay” to run the ignition acceleration procedure at more appropriate timing.

The degree of the fuel ignition delay in the above additional condition may include one of the fuel ignition delay of the pilot injection (see τp1 and τp2 in FIGS. 3 and 4), the fuel ignition delay of the main injection (see τm1 and τm2 in FIGS. 3 and 4), and the fuel ignition delay of the total of the injections (for example, a time length from a time to start the main injection to a time at which 10% of the total heat generation during the power stroke is generated).

To run the ignition acceleration procedure at more appropriate timing, the specific conditions may be replaced with a condition that both of the conditions are satisfied during an exhaust gas recirculation under the center position control. The conditions includes: first condition that a load of the engine is smaller than a threshold load; and second condition that a rotational speed of the engine is smaller than a threshold rotational speed. This is because the combustion noise may become larger when the both conditions are satisfied due to the fuel ignition delay compared when one of the conditions is satisfied.

In addition, the supercharging pressure may affect the fuel ignition delay, as described above. Hence, the control apparatus of the present invention is preferably used on the engine having a supercharger in addition to the EGR device.

The “load” is an index representing a load condition of the engine, and its specific parameters and obtaining methods are not limited. For example, the load include one or more of an output torque of the engine, a required torque for the engine (e.g., an accelerator pedal position), and a fuel injection amount determined by the required torque. Furthermore, the load may include a ratio of an actual amount of gas guided into the combustion chamber of the engine (an actual amount) to the maximum amount of gas to be guided into the combustion chamber (for example, a value obtained by dividing the total engine displacement by the number of cylinders). This ratio is commonly referred to as a load ratio.

Each of the “main injection” and the “pilot injection” is individual injection under the multistage fuel injection. For example, the main injection is to inject fuel mainly contribute to generate the output torque required for the engine (e.g., an injection by which the maximum amount is injected among the multistage injections). The pilot injection is to inject fuel before the main injection (in other words, at more advanced crank angle than the crank angle of the main injection) for reasons such as enhancing the fuel injection of the main injection. In addition, the multistage fuel injection may include one or more pilot injections.

When the multistage fuel injection includes a number of pilot injections, the control apparatus of the present invention may increase fuel amounts of all pilot injections or a part of the pilot injections. In this regard, the fuel amount of “the pilot injection just before the main injection” may be preferably increased to reduce the worsening of the fuel ignition delay of the main injection effectively. The pilot injection just before the main injection represents, for example, the second pilot injection under the case that two pilot injections are followed by the main injection.

The “reference position” of the center position control is an appropriate center position in heat generation ratio to enhance the fuel consumption rate of the engine, and its specific value is not limited. For example, the reference position may be a center position at which the fuel consumption rate is minimized. On the other hand, when considering requirements from the view point other than the fuel consumption rate (for example, requirements to reduce NOx in exhaust gas, to warm-up an exhaust gas purification catalyst quickly, to enhance a heat tolerance and strength of the engine, and to drive the engine properly under transient operation), the reference position may be a center position at which those requirements and the enhancement of the fuel consumption rate are achieved as far as possible.

The “predetermined range for driving status” may be determined to be a range in which the center position should be aligned with the reference position, in consideration of the fuel consumption rate as well as the above other requirements.

The “fuel consumption rate” is a value representing an amount of fuel used in the engine (in other words, a degree of consumption), and its parameters are not limited. For example, the fuel consumption rate may include one of a fuel consumption amount per unit output and per unit time (so-called BSFC, e.g., g/kWh), a fuel consumption amount per unit running distance of a vehicle with the engine (e.g., L/100 km), and a running distance of the vehicle per unit fuel amount (e.g., km/L). Furthermore, when fuel is used for a purpose other than driving the engine (for example, when fuel is injected into exhaust gas to burn and eliminate particle matters deposited in a diesel particulate filter), a fuel consumption amount for the purpose may also be included in the fuel consumption rate.

The term “performing a center position control to align a crank angle defined as a center position with a reference position” includes a combustion control to move the canter position close to the reference position when the center position does not align with the reference position and a combustion control to keep the center position to be aligned with the reference position when the center position aligns with the reference position. In addition, this term can be replaced with a term “controlling the center position to align with the reference position”.

Those combustion controls can be achieved, for example, by controlling combustion parameters relating to the center position control (for example, see the following items 1 to 12). In addition, performing those combustion controls are substantially the same as determining the combustion parameters (in other words, setting the combustion parameters at appropriate values depending on the engine driving status by using a feedforward control method and/or a feedback control method).

The combustion parameters may include at least one of the following items (1) to (12), which may be selected depending on, for example, a configuration of the engine:
(1) Timing of the main Injection;
(2) Fuel injection pressure (a pressure of fuel injected through a fuel injection valve);
(3) Fuel injection amount of the pilot injection;
(4) Number of the pilot injections;
(5) Timing of the pilot injection;
(6) Fuel injection amount of each pilot injection;
(7) Fuel injection amount of an after injection (a fuel injection started at more retarded crank angle than that of main injection);
(8) Supercharging pressure by the supercharger (for example, a nozzle position of a variable nozzle turbo (VN turbo) mechanism, and a waste gate valve position of a turbo system);
(9) Intake temperature (for example, a cooling efficiency of an intercooler, and a cooling efficiently of an EGR cooler. In particular, a gas amount bypassing the intercooler (or valve position of a bypass valve), and a gas amount bypassing the EGR cooler (or valve position of a bypass valve);
(10) EGR rate (or, EGR gas amount);
(11) Ratio of an amount of high pressure EGR gas to an amount of low pressure EGR gas (a high/low-pressure EGR ratio), where the high pressure EGR gas is exhaust gas recirculated by a high pressure EGR device to recirculate exhaust gas upstream of a turbine of the supercharger to an intake passage, and the low pressure EGR gas is exhaust gas recirculated by a low pressure EGR device to recirculate exhaust gas downstream of the turbine to the intake passage; and
(12) Strength of swirl flow in the cylinder (for example, a valve position of a swirl control valve).

To move the center position to more “advanced” position by using the above combustion parameters (1) to (12), the scontrol apparatus may control the parameters as follows:
(1a) Moving the timing of the main injection to more advanced position;
(2a) Increasing the fuel injection pressure;
(3a) Increasing the fuel injection amount of the pilot injection;
(4a) Changing the number of the pilot injections to move a partial center position, which is determined only based on the pilot injections, to more advanced position;
(5a) Changing the timing of the pilot injection to move the partial center position to more advanced position;
(6a) Changing the fuel injection amount of each pilot injection to move the partial center position to more advanced position;
(7a) Decrease the fuel injection amount of the after injection, or eliminating the after injection;
(8a) Increasing the supercharging pressure;
(9a) Increasing the intake temperature;
(10a) Decreasing the EGR rate (or, decreasing the EGR gas amount)
(11a) Decreasing the ratio of the amount of high pressure EGR gas to the amount of low pressure EGR gas; and
(12a) Increasing the strength of the swirl flow.

To move the center position to more “retarded” position, the control apparatus may control the parameters as follows:
(1b) Moving the timing of the main injection to more retarded position;
(2b) Decreasing the fuel injection pressure;
(3b) Decreasing the fuel injection amount of the pilot injection;
(4b) Changing the number of the pilot injections to move a partial center position, which is determined only based on the pilot injections, to more retarded position;
(5b) Changing the timing of the pilot injection to move the partial center position to more retarded position;
(6b) Changing the fuel injection amount of each pilot injection to move the partial center position to more retarded position;
(7b) Increasing the fuel injection amount of the after injection;
(8b) Decreasing the supercharging pressure;
(9b) Decreasing the intake temperature;
(10b) Increasing the EGR rate (or, increasing the EGR gas amount),
(11b) Increasing the ratio of the amount of high pressure EGR gas to the amount of low pressure EGR gas; and
(12b) Decreasing the strength of the swirl flow.

The control apparatus according to an aspect of the present invention is described above. Next, a control apparatus according to another aspect of the present invention will be described below.

The “reference position” is set to an appropriate value to reflect purposes of the center position control (main purpose is to enhance the fuel consumption rate) as described above.

For example, as another aspect of the present invention, the reference position, used in the center position control of the above control apparatus, may be set at “a position to minimize a fuel consumption rate of the engine”.

When determining the reference position to minimize the fuel consumption rate, the reference position is often set as a crank angle near the top dead center to increase the output torque as far as possible, as described above. In this case, the amount of exhaust gas recirculated by the EGR device typically increases to reduce NOx, since a large amount of NOx is generated due to high combustion temperature in the cylinder.

As a result, increasing the amount of the EGR gas (in other words, the EGR rate) can broaden the ignition delay when the engine satisfies one of the specific conditions compared with a case when the center position is far from the top dead center. Furthermore, decreasing the amount of the EGR gas is difficult without violating the purpose of reducing NOx. Using the control apparatus is able to reduce NOx as well as the combustion noise, even when the reference position is set as above.

Consequently, the control apparatus of this embodiment is able to reduce the combustion noise even when decreasing the EGR rate (or decreasing the EGR amount) is difficult due to the requirement to reduce NOx. As a result, the control apparatus of this embodiment is able to enhance the fuel consumption rate of the engine and reduce the combustion noise.

The reference position set at “a position to minimize a fuel consumption rate of the engine” may be replaced with, for example, “a position to maximize the output torque of the engine” or “a position near the top dead center”.

As described above, the control apparatus according to the present invention enables an internal combustion engine having an EGR device to improve its fuel consumption rate and reduce its combustion noise.

### BRIEF DESCRIPTION OF DRAWINGS

FIGS. 1A and 1B are drawings to explain center positions in heat generation ratio of the present invention.

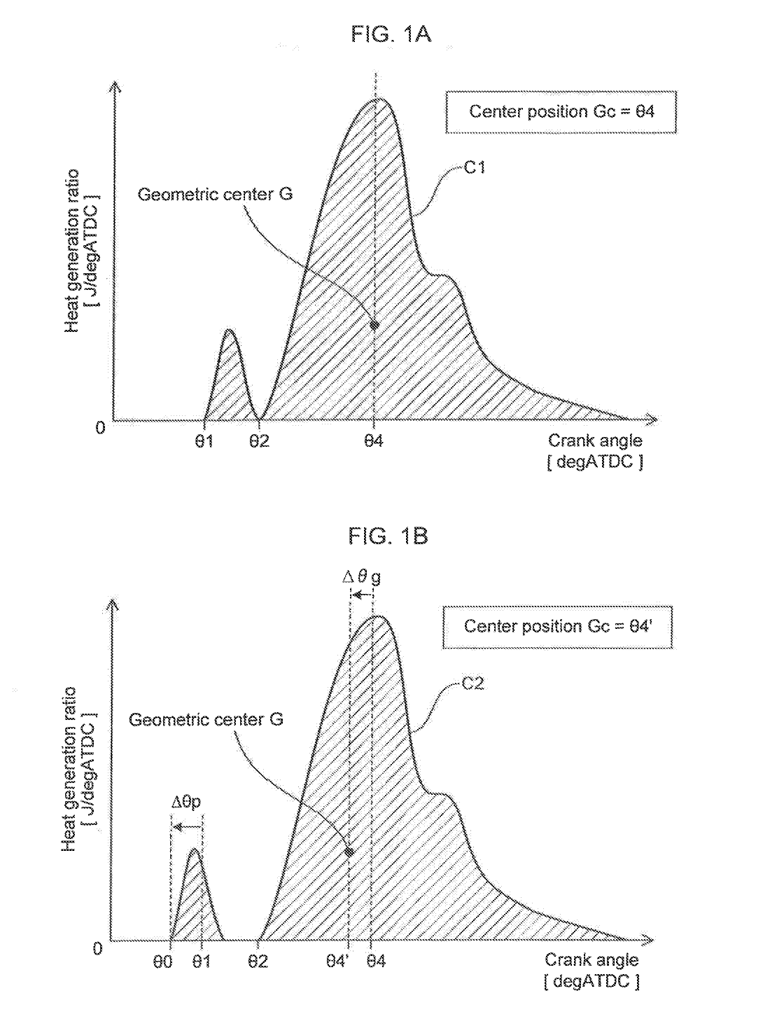

FIG. 2 is an explanation drawing illustrating an example of a relationship between the center position in heat generation ratio and deterioration rates of the fuel consumption rate.

FIG. 3 is an explanation drawing illustrating an example of a relationship between fuel combustion states and in-cylinder pressure of an engine (under normal ignition delay).

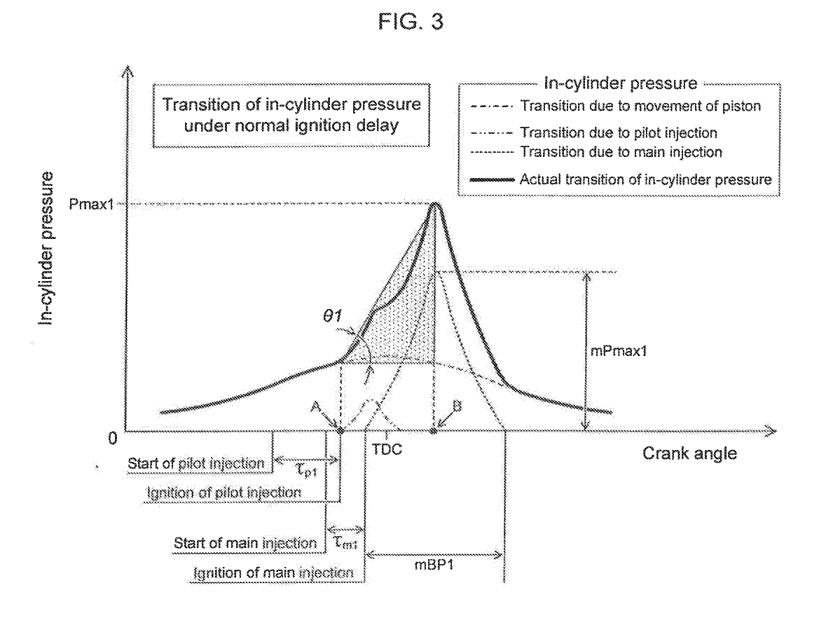

FIG. 4 is an explanation drawing illustrating an example of a relationship between fuel combustion states and in-cylinder pressure of an engine (under longer ignition delay).

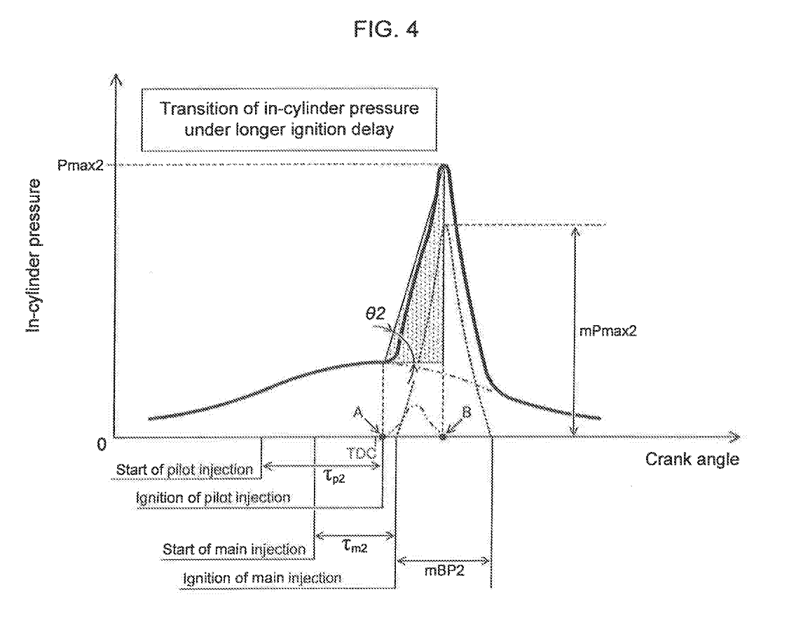

FIG. 5 is a schematic diagram illustrating a control apparatus according to an embodiment of the present invention and an engine for which the control apparatus is used.

FIG. 6 is a flowchart illustrating a schematic processing executed by the control apparatus according to an embodiment of the present invention.

FIG. 7 is a flowchart illustrating a routine executed by the CPU of the electronic control unit in FIG. 5.

FIG. 8 is a flowchart illustrating a routine executed by the CPU of the electronic control unit in FIG. 5.

FIGS. 9A and 9B are reference drawings each illustrating an example of the relationship between crank angle and heat generation under the multistage fuel injection including one pilot injection and one main injection.

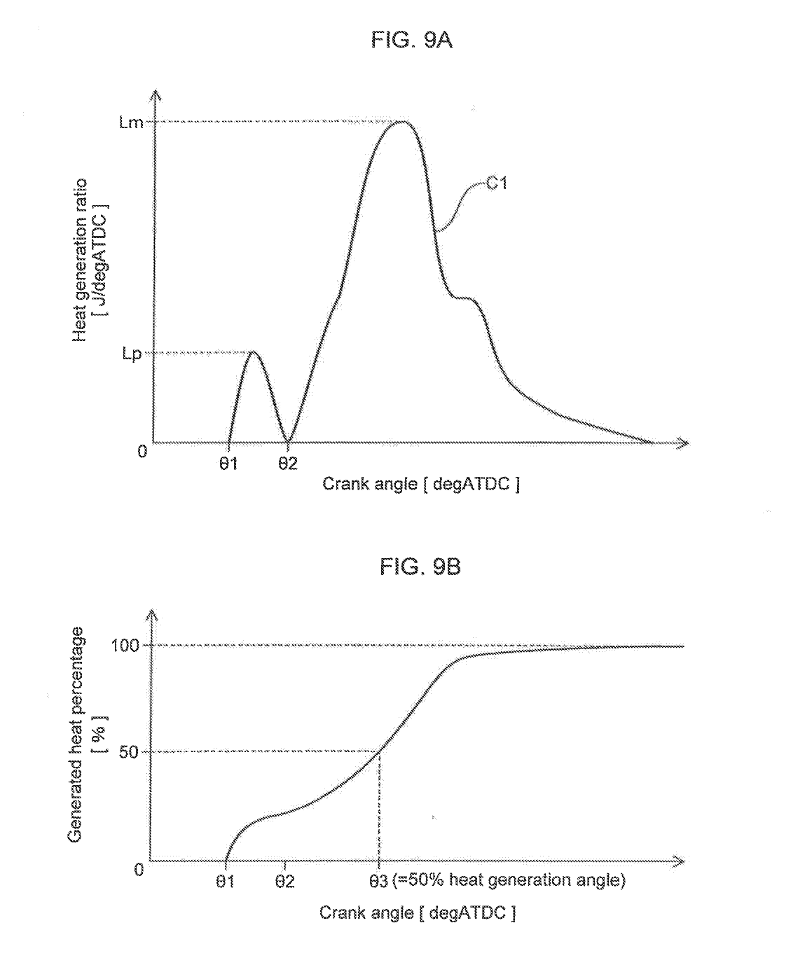

FIGS. 10A and 10B are reference drawings each illustrating an example of the relationship between crank angle and heat generation.

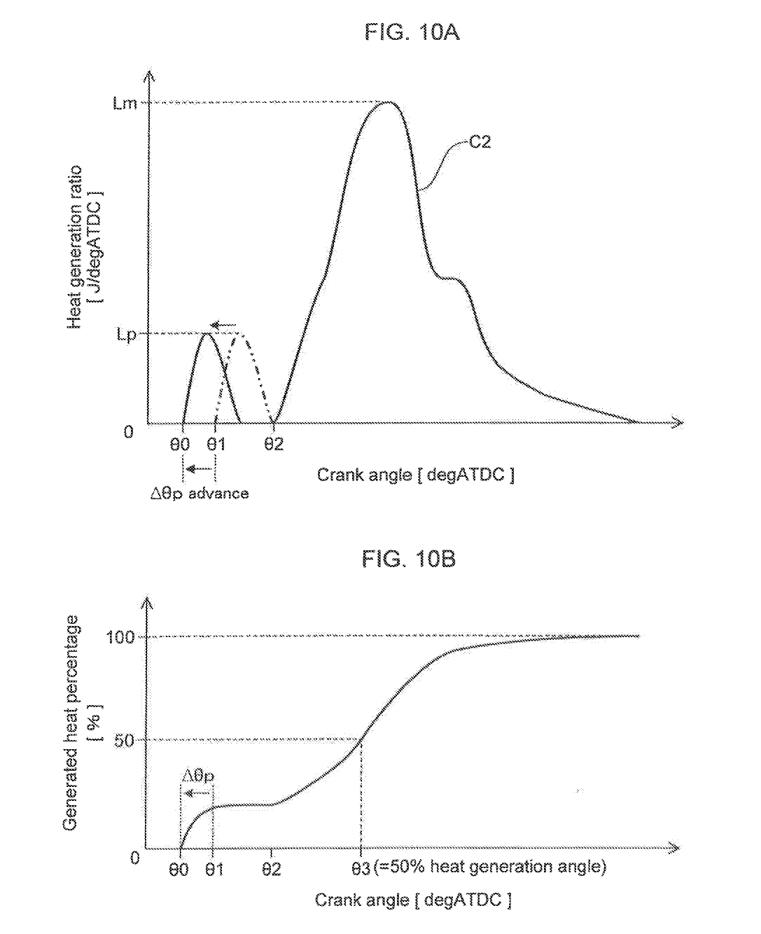

FIG. 11 is a reference drawing illustrating an example of the relationship between the 50% heat generation angle and deterioration rates of the fuel consumption rate.

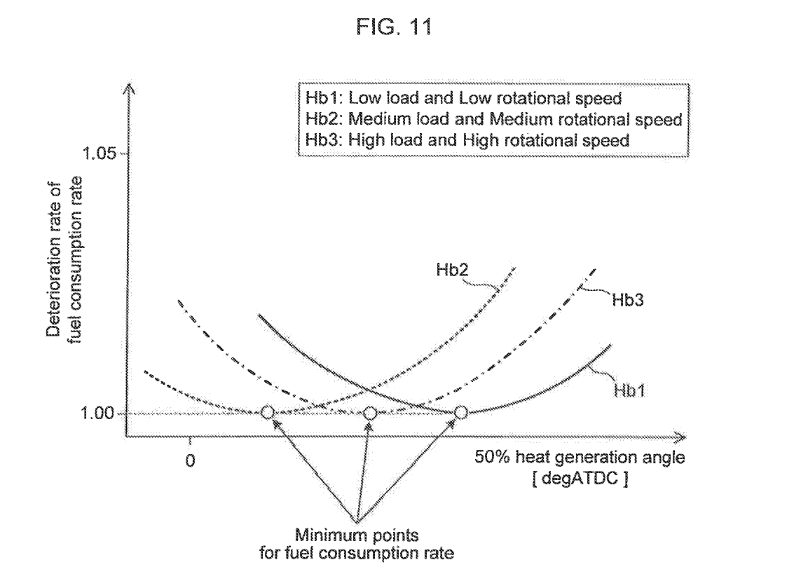

### DESCRIPTION OF EMBODIMENTS

### EXAMPLES

A control apparatus according to an embodiment of the present invention (hereinafter simply referred to as “control apparatus”) will be described by referring to the drawings.

### (Configuration)

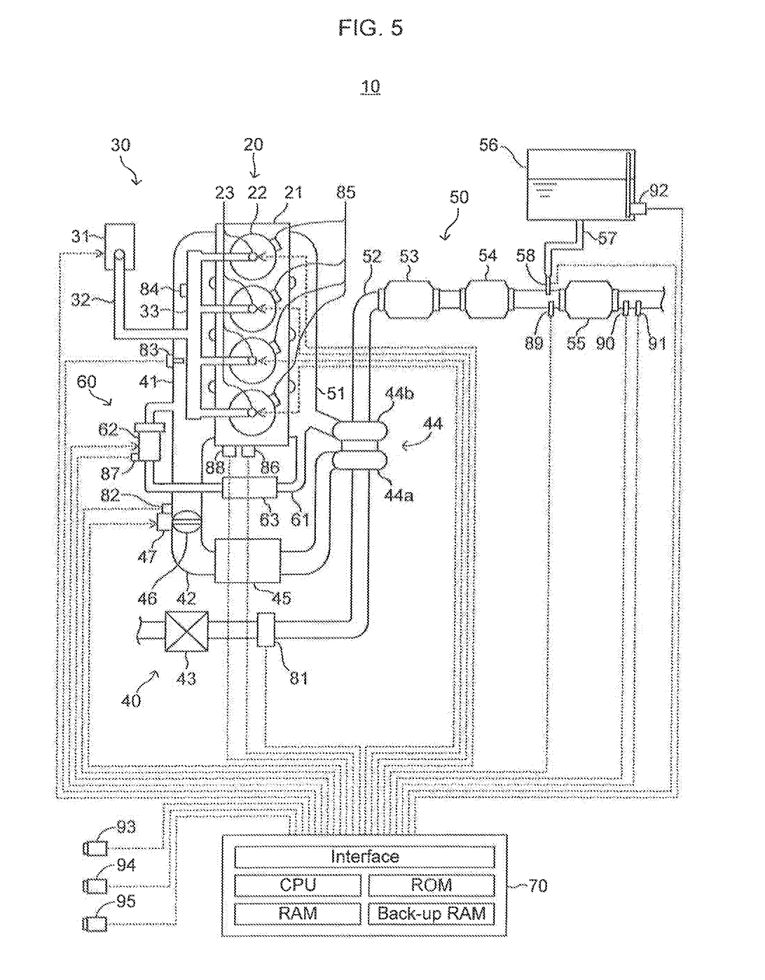

The control apparatus is used for the internal combustion engine 10 shown in FIG. 5. The engine 10 is a multicylinder (in-line four-cylinder) 4-cycle reciprocating diesel engine. The engine 10 includes a main body part 20, a fuel supply system 30, an intake system 40, an exhaust system 50, an EGR device 60, an electronic control unit 70, and various sensors 81-95.

The main body part 20 has a main body 21 including, for example, a cylinder block, a cylinder head and a crankcase. The main body 21 has four cylinders (combustion chambers) 22. The cylinders 22 each have fuel injection valve (injector) 23 in its headspace. The fuel injection valve 23 injects fuel into the cylinder at a specific moment in a specific time length as instructed by an engine electronic control unit (ECU) 70, which is described below, thus controlling fuel injection timing and fuel injection amount.

The fuel supply system 30 includes a fuel pressurizing pump (supply pump) 31, a fuel delivery pipe 32, and a common rail (accumulator) 33. The fuel delivery pipe 32 connects the fuel pressurizing pump 31 and the common rail 33. The common rail 33 is connected to the fuel injection valve 23.

The fuel pressurizing pump 31 pressurizes fuel pumped from a fuel tank (not shown) and then supplies the pressurized fuel to the common rail 33 through the fuel delivery pipe 32. The fuel pressurizing pump 31 controls the pressure of the accumulated fuel in the common rail 33 (fuel injection pressure) as instructed by the engine ECU 70.

The intake system 40 includes an intake manifold 41, an intake pipe 42, an air cleaner 43, a compressor 44a of a supercharger 44, an intercooler 45, a throttle valve 46, and a throttle valve actuator 47.

The exhaust system 50 includes an exhaust manifold 51, an exhaust pipe 52, a turbine 44b of the supercharger 44, a diesel oxidation catalyst (DOC) 53, a diesel particulate filter (DPF) 54, an urea SCR catalyst 55, an urea solution tank 56, an urea solution supply pipe 57, and an urea solution injector 58.

The EGR device 60 includes an exhaust gas recirculation pipe 61, an EGR control valve 62, and an EGR cooler 63. The exhaust gas recirculation pipe 61 connects an exhaust position located upstream of the turbine 44b on the exhaust pipe 52 (i.e., the exhaust manifold 51) to an intake position located downstream of the throttle valve 46 on the intake pipe 42 (Le., the intake manifold 41). The EGR control valve 62 is located on the exhaust gas recirculation pipe 61. The EGR control valve 62 changes a cross-sectional area of the exhaust gas recirculation pipe 61 as instructed by the electronic control unit 70, thus changing an amount of exhaust gas recirculated from the exhaust pipe 52 to the intake pipe 42. The EGR device 60 accordingly controls an amount of EGR gas (an EGR rate).

The electronic control unit 70 includes, for example, a CPU, a ROM, a RAM, a backup RAM, and an interface. The electronic control unit 70 receives signals from the various sensors 81-95, which are connected to the ECU 70, and sends instructions to the actuators from the CPU.

The various sensors 81-95 include an airflow meter 81, a throttle valve position sensor 82, an intake pipe pressure sensor 83, a fuel pressure sensor 84, a cylinder pressure sensor 85, a crank angle sensor 86, an EGR valve position sensor 87, a water temperature sensor 88, an exhaust gas temperature sensor 89 located upstream of the urea SCR catalyst 55, an exhaust gas temperature sensor 90 located downstream of the urea SCR catalyst 55, a NOx sensor 91, an urea solution level sensor 92, a vehicle speed sensor 93, a fuel level sensor 94, and an accelerator position sensor 95.

Each cylinder pressure sensor 85 located on each cylinder (combustion chamber) outputs signals representing a pressure value in the each cylinder (i.e., a cylinder pressure) Pc.

The crank angle sensor 86 outputs signals depending on a crank angle, which is a rotational position of a crank shaft (not shown) of the engine 10. The electronic control unit 70 obtains an absolute crank angle θ, which is a crank angle with reference to the top dead center (TIBC) of the compression stroke, based on the signals from the crank angle sensor 86 and a cam position sensor (not shown). Furthermore, the electronic control unit 70 obtains the rotational speed NE based on signals from the crank angle sensor

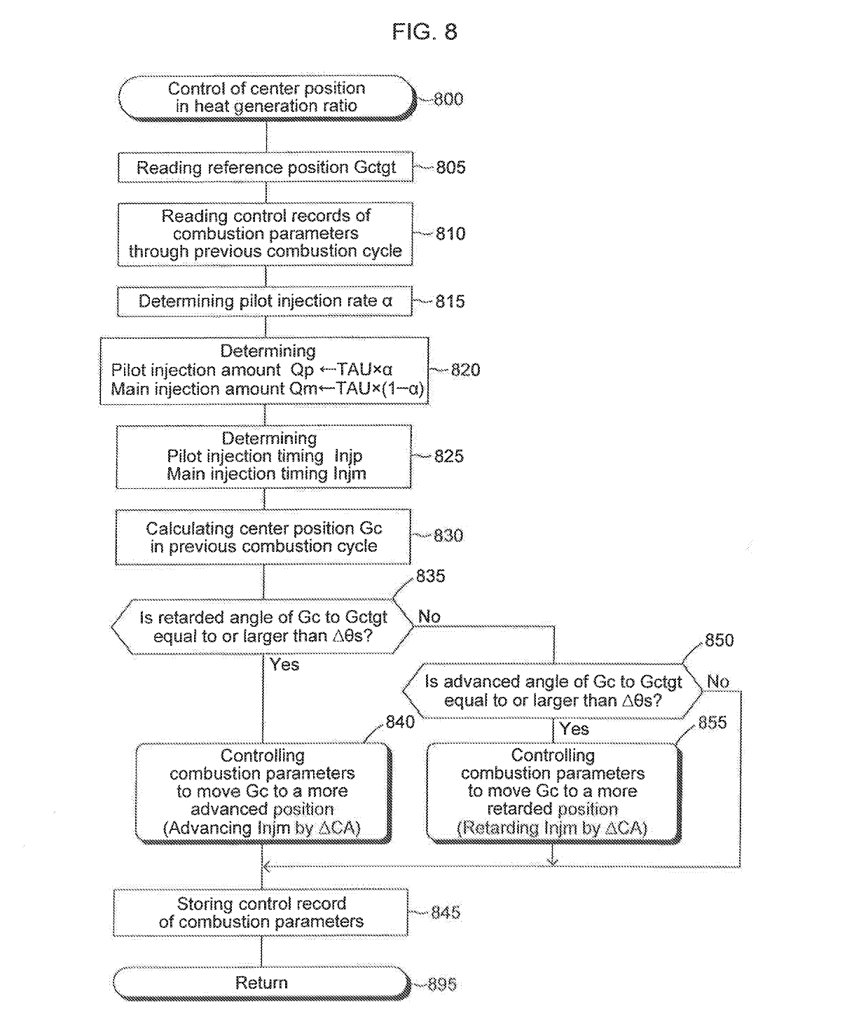

In addition, the electronic control unit 70 calculates a center position Gc in heat generation ratio, as described below (see step 830 in FIG. 8), based on the cylinder pressure Pc detected by the cylinder pressure sensor 85 and the crank angle θ detected by the crank angle sensor 86.

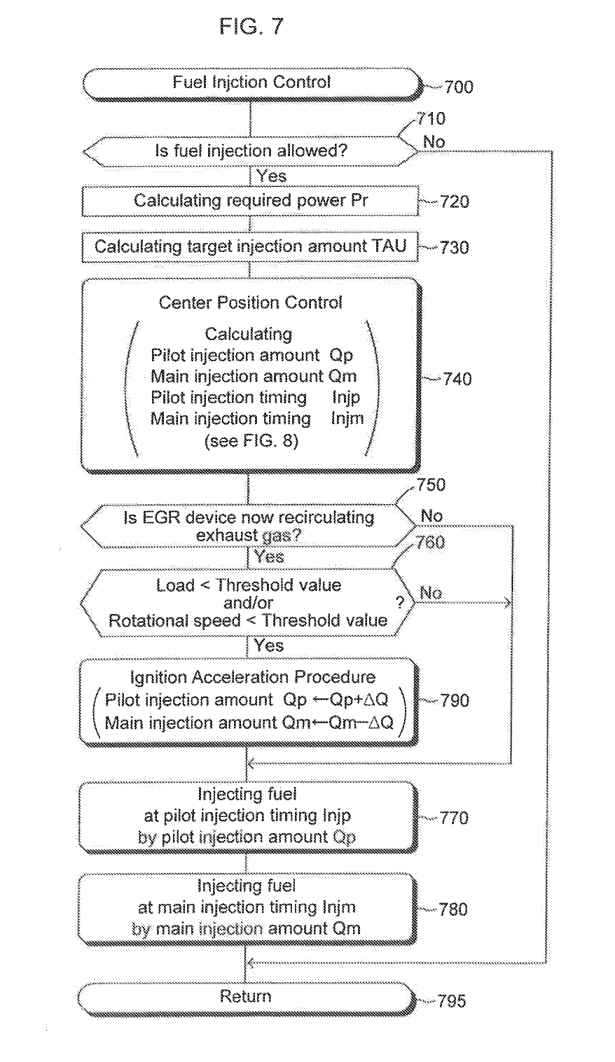

The EGR valve position sensor 87 outputs signals representing a position of the EGR control valve 62. In addition, the electronic control unit 70 is able to determine “whether the EGR device 60 is recirculating the exhaust gas”, as described below (see step 750 in FIG. 7), based on the signals from the EGR valve position sensor 87.

The water temperature sensor 88 outputs signals representing a temperature of coolant water (a coolant water temperature) of the engine 10. The vehicle speed sensor 93 outputs signals representing a running speed of the vehicle (a vehicle speed) Spd with the engine 10. The fuel level sensor 94 outputs signals representing an amount of fuel in the fuel tank (not shown). The accelerator position sensor 95 outputs signals representing an accelerator pedal position Accp (not shown).

The engine 10, for which the control apparatus is used, includes the main body part 20, the fuel supply system 30, the intake system 40, the exhaust system 50, the EGR device 60, the electronic control unit 70, and the sensors 31-95, as described above,

### (Operation)

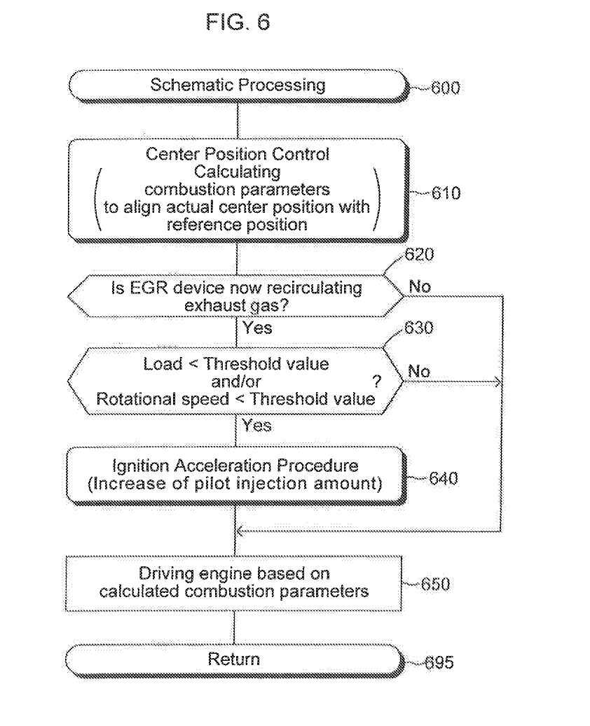

Next, an outline of operation of the control apparatus will be described by referring FIG. 6. FIG. 6 is a flowchart illustrating a schematic processing executed by the control apparatus.

At step 610, the control apparatus calculates various combustion parameters in accordance with the method of the center position control, which is described in detail below, to control the combustion parameters to align an actual center position in heat generation ratio with a predetermined reference position. In other words, the control apparatus drives the engine 10 based on the combustion parameters calculated at this step to achieve the center position control (see step 650).

In particular, the control apparatus stores relationships (e.g., maps) between the center position and the combustion parameters in the ROM of the electronic control unit 70. The control apparatus reads the combustion parameters from the ROM depending on an actual driving status of the engine 10 and controls the engine 10 by using the combustion parameters (i.e., a feedforward control), thus aligning an actual center position with the reference position. Furthermore, the control apparatus estimates an actual center position based on a cylinder pressure detected by the cylinder pressure sensor 85, and controls the combustion parameters to align the estimated center position with the reference position (i.e., a feedback control). This feedback control is unnecessary to achieve the center position control., Furthermore, the control apparatus may align an actual center position with the reference position by using the feedback control alone, without using the feedforward control.

Under the center position control, the control apparatus determines, at step 620 and step 630, whether the engine 10 satisfies “a specific condition for an Ignition acceleration procedure”. The ignition acceleration procedure includes an increase of the pilot injection amount than its amount determined based on the center position control.

In particular, at step 620, the control apparatus determines whether the EGR device 60 is now recirculating exhaust gas. Furthermore, at step 630, the control apparatus determines whether the engine 10 satisfies at least one of the following conditions: “the engine load is smaller than a predetermined threshold load”; and “the engine rotational speed is smaller than a predetermined threshold rotational speed”.

When determining as “Yes” at both of steps 620 and 630, the control apparatus allows its processing to proceed to step 640, thus running the ignition acceleration procedure. After that, the control apparatus allows its processing to proceed to step 650 to drive the engine 10 in accordance with the combustion parameters including the increased pilot ignition.

On the other hand, when determining as “No” at either step 620 or step 630, the control apparatus allows its processing to proceed to 650 directly, without step 640, to drive the engine 10 in accordance with the combustion parameters calculated for the center position control. The control apparatus thus controls the center position in heat generation ratio.

In addition, when starting the ignition acceleration procedure, the control apparatus continues the procedure until determining as “No” at either step 620 or step 630 (i.e., until the engine 10 does not satisfy the specific condition for an Ignition acceleration procedure). Under the ignition acceleration procedure, the control apparatus starts (or restarts) the center position control when it determines as “No” at either step 620 or step 630.

The control apparatus controls the center position in heat generation ratio as described above.

### (Fuel Injection)

Next, an actual processing of the CPU of the electronic control unit 70 (hereinafter referred to as “CPU”) will be described below. The CPU executes the “fuel injection control routine” in FIG. 7 at every predetermined time. In particular, the CPU starts the processing of this routine from step 700 at a certain time, then proceeding to step 710.

At step 710, the CPU determines whether fuel injection is now allowed. For example, when the engine 10 should now drive in the fuel-cut mode (i.e., under the fuel-cut drive), the CPU determines as “No” at step 710, proceeds to step 795, and then end this routine once. On the other hand, when the engine 10 now has no specific reason to disallow the fuel injection, the CPU determines as “Yes” at step 710 to proceed to step 720.

At step 720, the CPU calculates a required power Pr for the engine 10 based on the accelerator pedal position Accp and the vehicle speed Spd. After that, the CPU proceeds to step 730.

At step 730, the CPU calculates a target amount of fuel injection amount (i.e., a target injection amount) TAU based on the required power Pr. The target injection amount TAU corresponds to a total amount of a pilot injection amount and a main injection amount (i.e., a total amount of fuel injected through one combustion cycle) as described below. After that, the CPU proceeds to step 740.

At step 740, the CPU determines each combustion parameter for the “center position control”. In particular, the CPU executes at this step the “control of center position in heat generation ratio” routine in FIG. 8 to calculate each combustion parameter by using a feedback control method (for example, an “injection timing lnjm of the main injection”, which is one of the combustion parameters, is calculated by using this method) to align an actual center position Gc with a reference position Gctgt. In addition, the CPU executes this routine for each cylinder of the engine 10.

This embodiment assumes that the engine 10 is being driven under a specific range for driving statuses, in which range the engine 10 should be controlled in accordance with the method of the center position control. This specific range determined based on, for example, a structural strength and a heat tolerance of the engine 10, a start-up performance, and a performance in exhaust gas purification. This embodiment may employ “a predetermined range in load of the engine 10” as an example of the specific range.

The “control of center position in heat generation ratio” routine in FIG. 8 will be described in detail below.

### (Center Position Control)

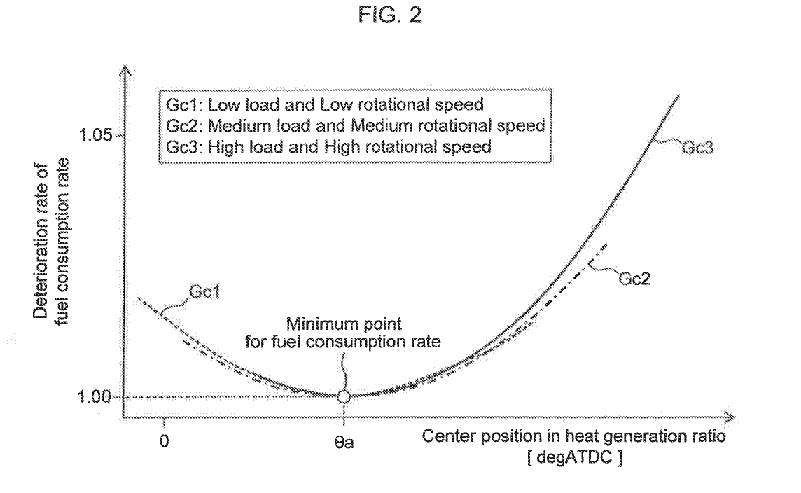

When proceeding to the routine in FIG. 8 through step 740, the CPU starts the processing of this routine from step 800 and then proceeds to step 805. At step 805, the CPU reads the reference position Gctgt of the center position in heat generation ratio. The reference position Gctgt in this embodiment is a crank angle θa determined to minimize the fuel consumption rate of the engine 10. The crank angle θa is a predetermined crank angle near the top dead center of the pressure stroke (for example, 7° CA after the top dead center), which crank angle has been specified in advance by experiments (see FIG. 2). The crank angle θa is stored in the ROM of the electronic control unit 70.

Next, the CPU proceeds to step 810. At step 810, the CPU reads, from the RAM of the electronic control unit 70, control records of the combustion parameters for the center position control through the previous combustion cycle (see step 845 described below). The control records in this embodiment include a degree of advanced/retarded angle of the main injection timing Injm. The CPU determines, at the following steps 815 to 825, each combustion parameter for this combustion cycle to reflect the control records of the combustion parameters. The combustion parameters in this embodiment include a pilot injection amount Qp, a main injection amount Qm, a pilot injection timing Injp, and a main injection timing lnjm.

In particular, the CPU determines, at step 815, a pilot injection rate a based on a coolant water temperature THW and an engine rotational speed NE. The pilot injection rate a represents the rate of the pilot injection amount to the total fuel injection amount (i.e., the target injection amount TAU). The pilot injection rate α is a value of 0≦α<1 (i.e., equal to or more than zero and less than 1). When determining the pilot injection rate a, this embodiment assumes that the engine 10 has one pilot injection through one combustion cycle. However, the engine 10 may have two or more pilot injections, and other embodiment of the present invention may assume the multiple pilot injections to determine the pilot injection rate α.

Next, the CPU determines, at step 820, the pilot injection amount Qp by multiplying the target injection amount TAU by the pilot injection rate α, and the main injection amount Qm by multiplying the target injection amount TAU by “the value (1-α) obtained by subtracting the pilot injection rate a from 1”.

Next, the CPU determines, at step 825, the pilot injection timing lnjp and the main injection timing lnjm to align the actual center position Cc with the reference position Gctgt. In particular, the CPU determines these timings lnjp and lnjm to reflect the combustion parameters (for example, the pilot injection amount Qp, the main injection amount Qm, the fuel injection pressure, and a supercharging pressure) and the control records of the combustion parameters through the previous combustion cycle (for example, a degree of advanced/retarded angle of the main injection timing lnjm). Furthermore, the CPU determines the timings lnjp and lnjm in this embodiment to arrange first burning due to the pilot injection and second burning due to the main injection continuously (i.e., to allow the first burning and the second burning to connect each other). In other words, the CPU determines these timings lnjp and lnjm to start the second burning during the first burning to achieve the continuous burning.

Next, the CPU proceeds to step 830. At step 830, the CPU calculates each heat generation ratio (each amount of heat generation per unit crank angle) through the previous combustion cycle based on the cylinder pressure Pc detected by the cylinder pressure sensor 85, then estimating the previous center position Gc in heat generation ratio based on the calculated heat generation ratios. In particular, the CPU calculates a heat generation ratio dQ(θ) [J/degATDC], which is an amount of heat generation per unit crank angle, for each crank angle θ[degATDC] by using a specific method (for example, see JP 2005-54753 A and JP 2007-285194 A).

Next, the CPU obtains (estimates) the previous center position Gc by applying the series of heat generation ratios dQ(U) to the following formula (3). See also the “fourth definition” described above. The center position Gc is actually calculated by using a digitally-converted formula of the formula (3). In the formula (3), CAs represents a crank angle at which certain fuel combustion starts, and CAe represents a crank angle at which the certain fuel combustion ends.

$$Gc = \frac{{\int }_{CAs}^{CAe} ( θ - CAs ) d Q ( θ ) d θ}{{\int }_{CAs}^{CAe} d Q ( θ ) d θ} + CAs \qquad ( 3 )$$

Next, the CPU proceeds to step 835 to determine whether a retarded angle of the calculated (actual) center position Gc with respect to the reference position Gctgt is equal to or larger than a threshold angle Δθs (a positive small angle). When the retarded angle is equal to or larger than the threshold angle Δθs, the CPU determines as “Yes” at step 835 to proceed to step 840.

At step 840, the CPU controls the combustion parameters to move the actual center position Gc to a more advanced position where the retarded angle becomes smaller than the original retarded angle. In this embodiment, the CPU advances the main injection timing Injm by a predetermined small angle ΔCA. The center position Gc thus slightly moves to a more advanced position, which is a closer positon to the reference position Gctgt.

Next, the CPU proceeds to step 845. At step 845, the CPU stores the control record of the combustion parameters (e.g., the main injection timing Injm has been advanced by the angle ΔCA, in this embodiment) to the RAM of the electronic control unit 70.

After that, the CPU proceeds to step 895 to end this routine once.

To the contrary, when the retarded angle is not equal to or larger than the threshold angle Δθs, the CPU determines as “No” at step 835 to proceed to step 850.

At step 850, the CPU determines whether an advanced angle of the actual center position Gc with respect to the reference position Gctgt is equal to or larger than a threshold angle Δθs. When the advanced angle is equal to or larger than the threshold angle Δθs, the CPU determines as “Yes” at step 850 to proceed to step 855.

At step 855, the CPU controls the combustion parameters to move the actual center position Gc to a more retarded position where the advanced angle becomes smaller than the original advanced angle. In this embodiment, the CPU retards the main injection timing Injm by a predetermined small angle ΔCA. The center position Gc thus slightly moves to a more retarded position, which is a closer positon to the reference position Gctgt.

Next, the CPU proceeds to step 845 to store the control record of the combustion parameters, then proceeding to step 895 to end this routine once.

As described above, the CPU controls the combustion parameters to align the actual center position Gc with the reference position Gctgt by using a feedback control method. After that, when both of the retarded angle and the advanced angle is smaller than the threshold angle Δθs (in other words, when the actual center position Gc is substantially equal to the reference position Gctgt), the CPU determines as “No” at steps 835 and 850, then ending this routine once without controlling the combustion parameters.

When ending the routine in FIG. 8, the CPU returns to step 740 in FIG. 7. Next, the CPU determines, at steps 750 and 760, whether the engine 10 satisfies “the specific condition for the Ignition acceleration procedure”.

At step 750, the CPU firstly determines whether the EGR device 60 is now recirculating exhaust gas. In particular, the CPU determines whether the exhaust gas recirculation is active based on signals representing a position of the EGR control valve 62 (i.e., output signals from the EGR valve position sensor 87). When the EGR device 60 is now recirculating exhaust gas, the CPU determines as “Yes” at step 750 to proceed to step 760. In this embodiment, the EGR device 60 may start or stop the exhaust gas recirculation to keep NOx concentration included in exhaust gas smaller than a predetermined threshold value.

At step 760, the CPU determines whether the engine 10 satisfies at least one of the following conditions: “an accelerator pedal position Accp of the engine 10 is smaller than a predetermined threshold position Accpth”; and “the engine rotational speed NE is smaller than a predetermined threshold rotational speed NEth”.

In addition, the CPU may employ, at step 760, a torque of the engine 10 (output torque) as an alternative to the accelerator pedal position Accp. Furthermore, the CPU may employ the target injection amount TAU as another alternative to the accelerator pedal position Accp.

When the engine 10 does not satisfy the both conditions, the CPU determines as “No” at step 760 to proceed to step 770.

At step 770, the CPU instructs the fuel injection valve 23 to inject fuel into the cylinder at the pilot injection timing Injp by the pilot injection amount Qp, which are determined in accordance with the method of the center position control (see step 740). Furthermore, the CPU instructs, at step 780, the fuel injection valve 23 to inject fuel at the main injection timing Injm by the main injection amount Qm, which are determined in the same manner. Thereby, the CPU controls the center position in heat generation ratio.

After that, the CPU proceeds to step 795 to end this routine once.

To the contrary, when the engine 10 satisfies at least one of the conditions at step 760 (in other words, the engine 10 satisfies the specific condition for the Ignition acceleration procedure), the CPU determines as “Yes” at step 760 to proceed to step 790.

At step 790, the CPU corrects the combustion parameters to run the “ignition acceleration procedure”. In particular, the CPU adds a predetermined correction amount ΔQ to the pilot injection amount Qp, which is determined in accordance with the method of the center position control (see step 740), and then uses the corrected value to update the pilot injection amount Qp. In other words, the CPU increases the pilot injection amount Qp by the correction amount ΔQ.

Furthermore, the CPU also corrects, at step 790, the main injection amount Qm. In particular, the CPU uses a value obtained by subtracting the correction amount ΔQ from the main injection amount Qm to update the main injection amount Qm. In other words, the CPU decreases the main injection amount Qm by the correction amount ΔQ.

Next, at steps 770 and 780, the CPU instructs the fuel injection valve 23 to inject fuel into the cylinder at the pilot injection timing lnjp by “the increased pilot injection amount Qp (equal to the original amount Qp plus the correction amount ΔQ)” and to inject fuel at the main injection timing lnjm by “the decreased main injection amount Qm (equal to the original amount Qm minus the correction amount ΔQ)”. Thereby, the CPU runs the ignition acceleration procedure.

After that, the CPU proceeds to step 795 to end this routine once.

When the pilot injection amount Qp is increased through “the ignition acceleration procedure” as described above, an amount of fuel included in a unit volume of air-fuel mixture increases, and a time length to inject fuel also becomes longer. The former allows the air-fuel mixture to rise its temperature rapidly, the latter allows the air-fuel mixture to enhance its dispersibility into in-cylinder gas. Thus, the ignition acceleration procedure is able to reduce worsening of the fuel ignition delay even under the specific condition. Accordingly, the control apparatus is able to choose an appropriate control method from first control method and second control method. The first control method includes setting the reference position Gctgt at a position (around the top dead center of the pressure stroke) where this method enables the fuel consumption rate to be enhanced. The second control method is to reduce combustion noise due to the worsening of the fuel ignition delay. Consequently, the control apparatus is able to enhance the fuel consumption rate of the engine 10 having the EGR device 60 and the supercharger 44 as well as to reduce the combustion noise.

As described above by referring to FIG. 5 to FIG. 8, the control apparatus according to this embodiment is used on the internal combustion engine 10 having an EGR device 60. The control apparatus has a control member (for example, the electronic control unit 70) performing the “center position control” to align a crank angle defined as a center position Gc with a reference position Gctgt (see steps 740, 770 and 780 in FIG. 7, and the routine in FIG. 8). The center position is a geometric center of a figure defined by heat generation ratio through a fuel combustion in a cylinder of the engine.

The control member 70 runs the “ignition acceleration procedure” when at least one of specific conditions is satisfied during an exhaust gas recirculation with the EGR device under the center position control (when being determined as “Yes” at steps 750 and 760). The ignition acceleration procedure is to inject more fuel for a pilot injection before a main injection than a base amount tip for the pilot injection determined in accordance with the center position control (see step 790, and the correction amount ΔQ). The specific conditions including: first condition of a load of the engine is smaller than a threshold load (the accelerator pedal position Accp is smaller than the threshold position Accpth); and second condition of a rotational speed NE of the engine 10 is smaller than a threshold rotational speed NEth.

In particular, the reference position Gctgt used in the center position control is set at a position (near the top dead center) to minimize a fuel consumption rate of the engine 10.

### OTHER EXAMPLES

While the present invention has been described in detail by referring to the specific embodiment, it is apparent that various modifications or corrections may be made by the person skilled in the art without departing from the spirit and the scope of, the invention. For example, the control apparatus, of the above embodiment employs, as the specific condition for the Ignition acceleration procedure, whether the engine satisfies at least one of the following conditions: an accelerator pedal position Accp of the engine 10 is smaller than a predetermined threshold position Accpth; and the engine rotational speed NE is smaller than a predetermined threshold rotational speed NEth (see step 760 in FIG. 7). However, the control apparatus of the present invention may employ, as the specific condition, whether the engine satisfies “the both” of the two conditions.

The control apparatus having the above configuration is able to run the ignition acceleration procedure at more appropriate timing than running the procedure when one of the two conditions is satisfied.

Furthermore, for example, the control apparatus runs the ignition acceleration procedure when the engine satisfies the specific condition under the center position control (when determining as “Yes” at steps 750 and 760), However, the control apparatus of the present invention may run the procedure when the engine satisfies, under the center position control, not only the specific condition but also an additional condition of the fuel ignition delay being larger than a threshold value. In particular, this embodiment can be formed, for example, by inserting an additional processing (an additional step) of determining a degree of the fuel ignition delay between step 760 and step 770 in FIG. 7. The degree of the fuel ignition delay can be determined, for example, based on a comparison between its target delay (e.g., a fuel ignition delay estimated from an engine load and a rotational speed) and its actual delay obtained based on a transition of the cylinder pressure.

The control apparatus having the above configuration is able to run the ignition acceleration procedure at more appropriate timing, because the control apparatus only runs the procedure when the fuel ignition delay actually worsens.

### REFERENCE SIGNS LIST

10: Internal combustion engine
22: Cylinder
23: Fuel injection valve
60: EGR device
85: Cylinder pressure sensor
86: Crank angle sensor
95: Accelerator position sensor

1. A control apparatus of an internal combustion engine having an EGR device,
the control apparatus comprising a control member performing a center position control to align a crank angle defined as a center position with a reference position upon the engine being driven under a predetermined range for driving status, the center position being a geometric center of a figure defined by heat generation ratio through a fuel combustion in a cylinder of the engine,
the control member running an ignition acceleration procedure upon at least one of specific conditions being satisfied during an exhaust gas recirculation with the EGR device under the center position control, the ignition acceleration procedure being to inject more fuel for a pilot injection of the engine before a main injection than a base amount for the pilot injection determined in accordance with the center position control, the specific conditions including: first condition of a load of the engine being smaller than a threshold load; and second condition of a rotational speed of the engine being smaller than a threshold rotational speed.

2. The control apparatus according to claim 1,
wherein the reference position used in the center position control is set at a position to minimize a fuel consumption rate of the engine.
